(19) United States
(12) Patent Application Publication
(10) Pub. No.: US 2012/0232946 A1
(43) Pub. Date: Sep. 13, 2012

(54) Methods and Systems for a Multi-Party Customizable Calendar

(76) Inventors: Charles Daniel Cocanougher, Justin, TX (US); Robert Allen Cocanougher, Southlake, TX (US); Stephen Ford Chambers, Justin, TX (US); Bradley Allen Dodd, Keller, TX (US)

(21) Appl. No.: 13/412,060

(22) Filed: Mar. 5, 2012

Related U.S. Application Data
(60) Provisional application No. 61/450,455, filed on Mar. 8, 2011.

(51) Int. Cl. G06Q 10/10

(52) U.S. Cl. 705/7.19

(57) ABSTRACT

A method and system for a real time multi-person scheduling system for creating and tracking the availability of persons, places, or things which may be required for an appointment. The scheduling system where an appointment can be created and tracked in real time and the system is configured to allow for remote access and amendments to an appointment through data transmission protocols. The scheduling system further providing for the tracking of persons, places, or things, such that parties to the appointment may track their hours and pay an attendee of an appointment or bill a client for the time expended.

### CROSS-REFERENCE TO RELATED APPLICATIONS

This application claims priority to U.S. provisional application Ser. No. 61/450,455 filed Mar. 8, 2011, which is incorporated herein by reference in its entirety.

### COPYRIGHT NOTICE

A portion of the disclosure of this patent document contains material, which is subject to copyright protection. The copyright owner has no objection to the facsimile reproduction of the patent document or the patent disclosure, as it appears in the Patent and Trademark Office patent file or records, but otherwise reserves all copyright rights whatsoever.

### FIELD OF INVENTION

The present invention is generally related to an online calendaring system which allows multiple parties to organize and arrange schedules as well as communicating, updating, and tracking of schedules in real time.

### BACKGROUND

Calendars, in some form or another, have existed for millennia. In the course of the modern economy, people kept calendars for, among other reasons, scheduling their appointments. One would block off their time on a paper calendar and edit by crossing out, or erasing an appointment. More modernly, personal calendars are software products that are managed and kept by individuals, either in their computer, such as Microsoft Outlook, or on the phone such as icalendar for iphone, or some still use antiquated calendars on their desk in some paper form. The appointments are put on the calendar by the singular person, and updated by the same or a person with access to that person's calendar. The calendar is minimally portable from one system to the next or from one place to the next. Some calendars allow others to view or enter data. Some calendars are kept on the web, or accessible by the web and are therefore more portable.

Traditional calendaring programs are not organized to allow multiple parties and entities to merge their schedules to provide a real time view of appointments. While business calendaring programs provide a view of another's schedule and allow for some customization of availability, they do not allow each entity to be fully customizable. In addition, features to allow parties to modify their calendar require access and entry to a system, so as to change availability. No program currently allows a business to plan its hours, its employees, and its customers in real time. In this situation, businesses often rely on simply posting available hours, or basic scheduling, that is driven by a singular person.

There are currently many types of “business directory” websites such as the yellow pages (YP.com), YELP.com, and others. These typically take public information derived from business filings, and post up these large databases for the owner of the business to “claim” their business, and generally start paying a fee for the marketing benefits associated with the “aggregate” effect of that business directory. However, these business directories usually suffer from stale and stagnant information, since the owners of the business may not “control” the information posted there. And therefore, these business profiles do not have the ability to schedule online appointments and reach into the business's scheduling directory since the profile is not completed by the business owner.

### SUMMARY OF THE INVENTION

These problems, and others which will become apparent from the following disclosure and drawings, are addressed by the present invention which comprises in one aspect, a method for creating a real-time schedule among multiple parties, where a database stores criteria and availability for one party, then a business sets the criteria for which they are available for an appointment, and a consumer then sets an appointment with the business based on those criteria.

Another aspect of the invention is a method for tracking the schedule of an employee by first creating a database of information related to an employee to create the employee's schedule; a second interface then allows a user an opportunity to set an appointment with said employee and finally tracking the start and stop times of the appointment.

Another aspect of the invention is a method for tracking the status of an appointment generated through a real-time schedule among multiple parties, where a database stores criteria and availability for one party, a business sets the criteria for which they are available; a consumer then sets an appointment based on those criteria; and tracking the start and stop times for an appointment and storing said times in a database; and finally notifying a later scheduled appointment of the change in status of an appointment and providing an estimate for the later appointment's start time.

Another aspect of the invention is a combination calendar and advertising product where an appointment is created by a first user, the first user's information is then stored in a database and the profile of that user generates a generic user profile for someone who uses the business, the product then creates and targets other similar profiles by offering them a coupon; and publishing the appointment and coupon on the first user' social network.

A scheduling system that comprises a computer server and a database of a plurality of persons and things that is configured to receive a request for an appointment and to schedule an appointment when available between a person and a thing.

A scheduling system that comprises a computer server and a database of a plurality of persons and things that is configured to receive a request for an appointment to schedule at least two people and an object, such that there are three required parties to an appointment.

A scheduling system that comprises a computer server and a database or a plurality of persons and things that is configured to receive a request for an appointment to schedule at least two people, an object and a location for a meeting.

Another aspect of the invention is an automated scheduling system that provides for a business to create a personal schedule for all employees and allowing the schedules of all employees to be visible in real-time so that customers may schedule appointments with the employees at a defined time and location.

### BRIEF DESCRIPTION OF THE FIGURES

FIG. 1 illustrates a basic user account that any person would have to create a schedule or for the user's personal appointments. One user has scheduled an appointment with a business, then that business's appointment would show up in the figure.

FIG. 2 illustrates the first step in how a customer of a business would select an appointment from a business.

FIG. 3 illustrates selecting an individual person with many services.

FIG. 4 illustrates a basic scheduling interface where open/available times are displayed to the end user.

FIG. 5 illustrates a close up of the scheduling interface that an Owner or Schedule Administrator person would see for an account with multiple users.

FIG. 6 illustrates the full view a particular month of the schedule administrator.

FIG. 7 illustrates the ability to schedule, for example, a private tennis lesson, requiring “people” to attend, both the paying customer and the professional giving the lesson, as well as “places and things,” which would be the tennis court that is required for performing the lesson.

FIG. 8 illustrates the ability to schedule, for example, a private tennis court, requiring “places and things,” which would be the tennis court that is required for the schedule.

FIG. 9 illustrates a simple month view with only an owner.

FIG. 10 illustrates the full view day view of the Schedule Administrator for a given schedule.

FIG. 11 illustrates simple view of the Day view of the schedule admin for a single user account.

FIG. 12 illustrates that “unscheduled” appointments may exist on a user's profile, but that the appointments have not yet been placed on a definitive date. This provides the profile with an advanced “to do” list and allows the Owner of the profile to manipulate those free appointments where appropriate.

FIG. 13 illustrates a six step process for creating an appointment

FIG. 14 illustrates a 14 step flowchart that the system uses to create and manage an appointment.

FIG. 15 illustrates the combination of four schedules, and how each of the schedules matches up to provide appointment times that works for each of the four schedules.

### DETAILED DESCRIPTION

### Definitions

People means the calendar of a real person or a business. Multiple people and multiple businesses may all fall under the heading of a single calendar, and all the schedules may be incorporated into large complex schedules involving numerous other schedules.

Places and Things means the calendar of physical locations or accessories, including abstract concepts such as services delivered or activities, which may be required for any schedule. Thus, a schedule for a tennis lesson may require a tennis court, a tennis racquet, a ball machine, tennis balls, an instructor, and the student. The tennis court, the racquet, ball machine, and balls are Places and Things, while the instructor and student and People.

Owner means the person responsible for the content on a schedule. Thus, an Owner may have only one schedule and it may be for herself. Conversely, an Owner may have a business with 200 employees, each of whom also has a schedule.

Service industry means activities or business suited for providing service to another person, place, or thing, including but not limited to food and beverage service, exercise and fitness, salon services, professional corporations, real estate, medical and dental, repair services and maintenance, cable or internet installation, and third party delivery services.

Real-time means the amount of time necessary to transfer information provided by a user into the database and update the database to show the new information for a particular schedule.

Data Transmission Protocols means any one of a variety of protocols, including HTTP, HTTPS, SMTP, ESMTP, SMS, XML interface, Smartphone “push notifications,” and other known and unknown ways of transferring internet protocol data.

As used herein, terms such as “a,” “an,” and “the” include singular and plural referents unless the context clearly demands otherwise.

### A Customizable Calendar

The embodiments described herein provide methods and systems for making a customizable calendaring system which is accessible by multiple parties. Calendars are typically modified by a single person, the user, and appointments are set and modified on that calendar according to that user's demands. However, with ubiquitous internet accessibility, consumers seek greater access and feedback from businesses.

The calendar system described in these embodiments is utilized through Data Transmission Protocols. For example, a business who wants to set up a personalized website as well as calendar for their business, accesses a web based system, which is a database driven calendaring program that provides flexibility and enhanced functionality. The Owner then inputs their business's information, the times they are open and, through a fully customizable interface, provide coupons or other features as first step set of entries for the calendar.

For each appointment there is an originator, owners, participants, spreadors (people who want to dissipate the appointments or information contained therein), informationals (persons who want to just have or view the information); and a person may change from one status to the other as allowed. Each of the people may view an appointment and may schedule appointments based on the availability of another. One embodiment provides that the “owner” of the business is the one that controls the business details on her website. Information such as the contact name, address, and phone number will be required. Here, the business owner has their first choice in preferences how to be contacted. An owner may be contacted via phone, text message, or email, or other means for being contacted. The Owner enters in all the information into the database, and the information is not mined from public sources of information, it is truly user generated. This provides for a better, more descriptive entry than the other generic sites.

The Owner then creates a complete profile of their hours and accessibility. Through the web based program the Owner should have information including the emails, phone numbers, addresses, and hours for each employee to be included within the program. The Owner should also have the available hours for any piece of property which may be used by an employee or a customer. Finally, the owner may include pictures and other text relating to the business. The schedule is fully customizable and an Owner is not limited in the content she may provide on her schedule and website.

The Owner should enter all information about a business: location, business email, phone, and address. The email of the business has a different function than the emails of employees listed in the site and the master email used to log into the system. The log in email and employee emails will receive notifications while the business email listed in this “Business Locations” section is there for display purposes on the homepage. Also, the owner here may enter and modify the times in which your business operates. This provides an overview of the business but does not show each and every detail of the schedule.

Once a profile has been established, the calendar function is utilized to make appointments that are viewable in real-time. The calendar for a particular profile is the personal calendar of that profile and is essentially a view into all the events that one is interested in participating in. A business may set up a profile for each and every one of its employees. A business may also set up a profile for Places and Things, like a conference room. A business may also create a profile for articles that are rented by the public, for example a tennis court that is rented, or a tool that is rented from a garden shop. Any person, place, or thing that may need to be included within an appointment may have its own profile. This ensures that a complete real-time schedule is available, and appointments can be created with all required people, places, and things being available for that appointment. Absent a profile for each person, place, or thing, a complete real-time calendar is unattainable.

Most of the events one would want to participate in are not actually owned by the person and therefore, should not be completely controlled by him. For example, a public tennis court is not the property of a user who wants to play on it. Thus, the schedule for that court is retained by the owner of the court, and is modified by that user. By providing a profile for the tennis court, the count can now be controlled in real-time. Thus, where the schedule is free for the court, a user may make an appointment. The Owner of the court schedule may require confirmation or payment to confirm the appointment, but each requirement is left to the individual Owner. This creates a real-world solution to one's calendar.

In another example, one's dentist appointment is only partially in one's control. It is mostly in the control of the Dentist office, so they should be the owner of this event. The person should also have rights to view and request changes and communicate through this event or appointment. Another instance is a High school Football game where one wants to attend. These events are completely controlled by a third party, but one wants to view the event and all changes that might be made to it. Many events or appointments that one has that include other family members are actually mutually controlled by all. In very few cases are you actually in control of your own calendar, yet most all calendar programs work where you are almost 100 percent in control. The embodiment creates a calendar for each person that directly relates to the reality of the situation. The embodiment also shows that an appointment may be simply something that a user wants to do, i.e. attend a High School Football game, but that the attendance is not necessary or required, nor would an update be required to the High School Football schedule because a user is not attending the game.

When customizing the schedule, an owner has flexibility. Any offers or promotions the owner wants to make public to customers may be displayed on a schedule. The Owner may set the dates in which the offer is valid, which provides a start and stop date or time for the offer. When the offer expires, it will no longer appear on the schedule or on the website. In this manner, an electronic coupon is available in real time. The Owner may also identify any important information that she wants available to customers. Such information may be identified on a schedule or in additional tabs identifying such information.

When a customer seeks to make an appointment they may view the availability of another person or entity in real-time, and enter into an appointment without additional communication. When a customer schedules an appointment, the Owner may provide marketing questions to gather additional data, such as gender, age, zip code, or even personal health information (when appropriately needed). Once an appointment is scheduled, the Owner and customer may determine what additional requirements are necessary for the appointment. For example, an interface provides options: Book appointment and send notifications to Service Provider, Customer must confirm the appointment through email, phone, or internet, Business may only take pre-approved customer appointments, and Business may make appointment pending until further considerations. These are merely extemporary but provide context as to the combination and extent of options available.

An Owner may also input business information, which allows the Owner to modify the business schedule. The business may set up small events for up to 10 people, large events for more than 10 people, share a personal calendar, invite others to join an event, appointment, or meeting, and email or text persons to remind them of events or meetings. An Owner may also schedule with its customers on a 24/7 basis, automate tasks, schedule staff members, meetings, and appointments; receive alerts and updates for appointments, and to create advertisements for the businesses webpage. The Owner may enter the name of the business, upload a picture for a logo, give a description, and provide the city in which the business is located. The Owner may manage whether appointments require confirmation. If confirmation is required for appointments customers create, a message will be sent to the schedule/admin inbox which can be accepted or declined. The Owner may also select when the user wants to receive reminders on appointments. An Owner has two choices for receiving reminders, via text and/or email.

### Creating an Appointment

The actual scheduling aspects require each of the steps to work in conjunction with the others to function properly. An Owner should create a schedule for all employees. Although email is not required, it is strongly recommend so that employees may receive alerts and reminders about appointments. To begin, first the Owner needs to enter the job position(s) for her employees. Each position may require individualized criteria. Where there are several different job positions in the business, the appropriate amount of categories must be created. After creating job position(s), enter the personal information of the employees under that job position. Making the person an administrator gives the employee the ability to make changes/updates to the site when he/she logs onto the site. The Owner may want to personalize each employee page. For example, a business that sends a technician to a home may want to include a picture of the technician, so that a customer knows who is coming to provide service.

Because each entity that may be schedule requires a profile, any extra places and things in a business that may be scheduled, needs a personal schedule. However, each business is unique and may have different requirements. For example, A hairstylist might only need a person (the hairstylist), and the type of appointment (color, highlights, cut, trim, etc.) for a functional schedule. A tennis center might need a person, the tennis pro, a Place, the court to conduct a lesson, and the type of lesson, private or group for a functioning schedule. The requirements for a schedule are fully customizable for each appointment, either specifically, or customizable for a category of appointments.

To complete the scheduling for a business add as many types of appointments as a required for the business, and set the times they're available to customers. Where appointments have a specified duration, the minimum length and maximum length for each should be identified. However, there will be appointments that have an undefined time, and these appointments may last until they are complete. For example, a tennis lesson for one hour has a minimum length of one hour and a maximum length of one hour. Another lesson may be able to be scheduled immediately after the completion of the previous engagement. However, a plumber may have an appointment that takes an undefined amount of time. If there is a second appointment on the plumber's calendar for that day, the plumber can manually update the schedule to identify the completion of the first appointment, which means the next appointment will occur soon. The schedule can send a message to the customer that their appointment is next. The schedule can also track the amount of time that each appointment took. So, for the plumber example, if the plumber is a contract worker, and is paid by the hour, not per job, the business owner could identify the amount of time it took to complete the job and pay the plumber accordingly.

One can also schedule multiple appointments occurring at the same time. Where a user has a doctor's appointment, they may also schedule a house cleaning service at the same time. A user may schedule three appointments at the same time, such as a doctor's appointment, a house cleaning service, and that their child has a play date during that time. A user may schedule virtually unlimited number of appointments, either at the same or different times.

The ability to track appointments and to make changes to the database can be achieved through codes sent to a service provider. For example, some codes may be “@arrived,” or “@done,” or “@enroute,” which provides the service provider with coding to update the schedule for a particular user and thereby updates the database with the information transmitted via a Data Transmission Protocol. The embodiment also contemplates providing unique coding for various smart phones, and or application based programs for a smart phone.

The ability to track the schedule provides for real time analysis of a businesses employees, the hours they have worked, their efficiency, and other statistics. Patterns may be understood by analyzing the data, and businesses can plan future appointments accordingly, or reward employees that are essential to the business.

Where an appointment needs to be changed, or one that has an undefined beginning and end, it is possible to require each appointment being communicated via means for communication, including via various Data Transmission Protocols. However, where an appointment is communicated via any Data Transmission Protocol, the schedule program can generate codes to update the database via a Data Transmission Protocol to update an appointment time, or to end an appointment, or other criteria as needed. Similarly, one may change a future appointment via a Data Transmission Protocol. In this manner, a customer and business need not speak on the phone or even access the internet, appointments may be made or modified via the mechanics of the Data Transmission Protocol.

The embodiment contemplates orchestrating multiple appointments in real-time. Because all the information about a persons schedule is identified in the database, it is possible to do a more complicated multi-appointment that joins many appointments together at the same time. For instance, when one schedules a dentist appointment for 10 am, they also may need to schedule the trip to and from the dentist, so their schedule actually says: 9:00 to 10:00—get ready and travel to dentist, 10:00 to 11:00—dentist, 11:00 to 12:00 pm—travel back to house from dentist. Another example is: 10:00 to 11:00—play tennis; 11:00 to 12:00—massage; 12:00 to 1:00—lunch. It could be that the person scheduling wants to schedule all these things together, or she is required to do so. The system process could allow her to put the total schedule in at the same time, even though each of these appointments is separate and has different participants they may be necessary for the person to schedule.

The embodiment contemplates the use of executable software via mobile devices which mimic the online schedule. The smart phone is connected via one of various Data Transmission Protocols and runs and operates just like the internet site in real time. The embodiment provides that the data in a mobile device is the same data as found via the full website based program, and not a separate copy of the data running independently.

### DETAILED DESCRIPTION

Reference is now made to the drawings which illustrate certain embodiments of the invention.

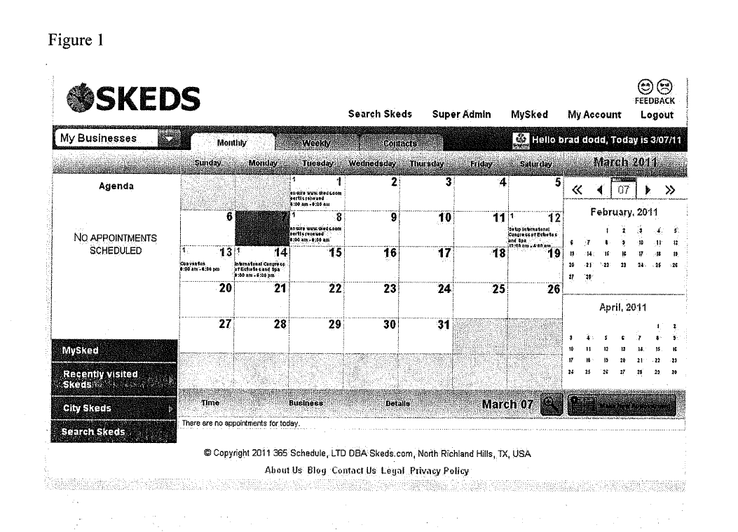

FIG. 1 illustrates a basic user account that any person would have to create a schedule or for the personal appointments that someone has. If someone has scheduled with a business, then that business's appointment does show up here. But the user has limited control over or ability to cancel an appointment if the business allows it.

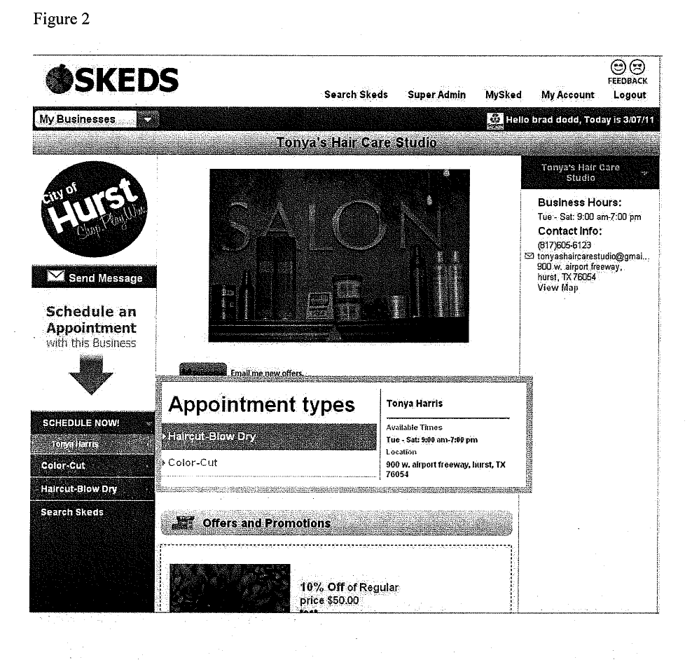

FIG. 2 illustrates the first step in how a customer of a business would select an appointment from a business, including who to schedule, what type of appointment, and what time and duration for the appointment.

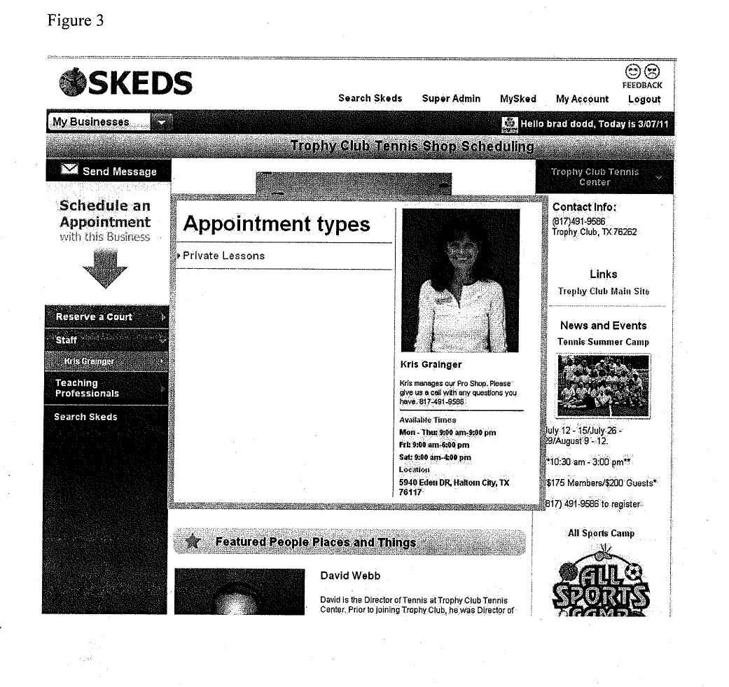

FIG. 3 illustrates selecting an individual person with many services.

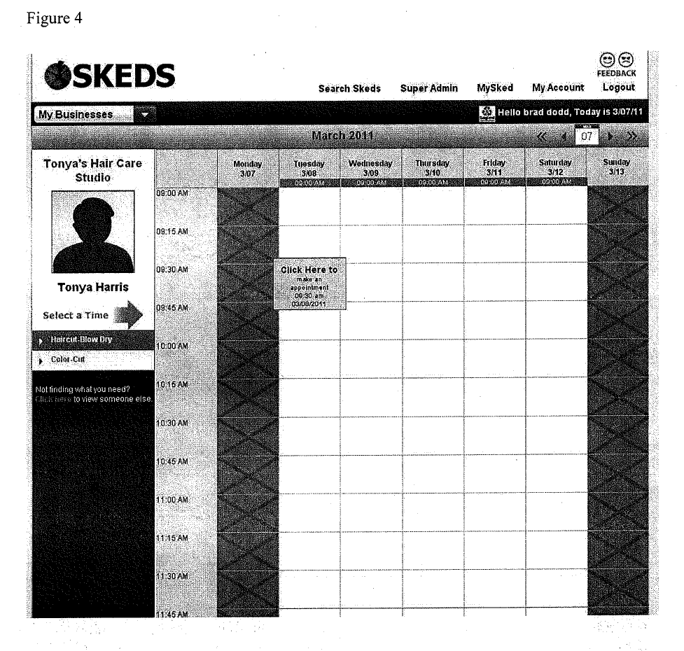

FIG. 4 illustrates a basic scheduling interface where open/available times are displayed to the end user and would show any appointment schedule in its particular time slot.

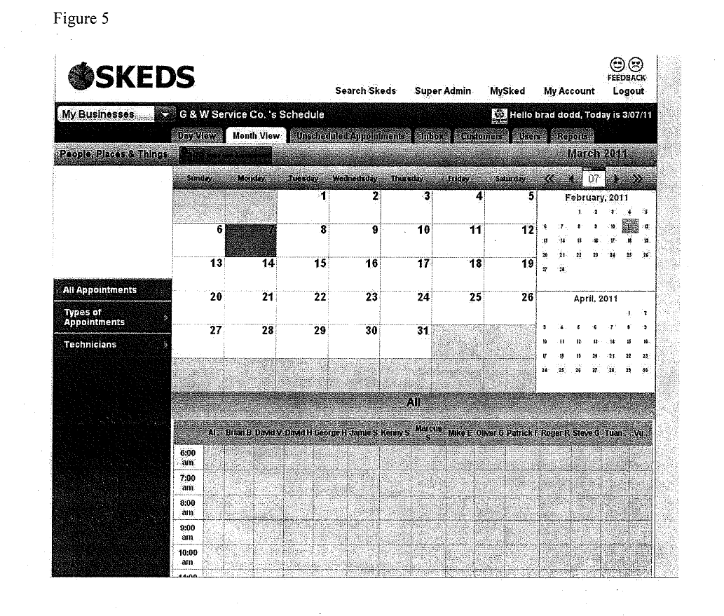

FIG. 5 illustrates a close up of the scheduling interface that an Owner or Schedule Administrator person would see for an account with multiple users.

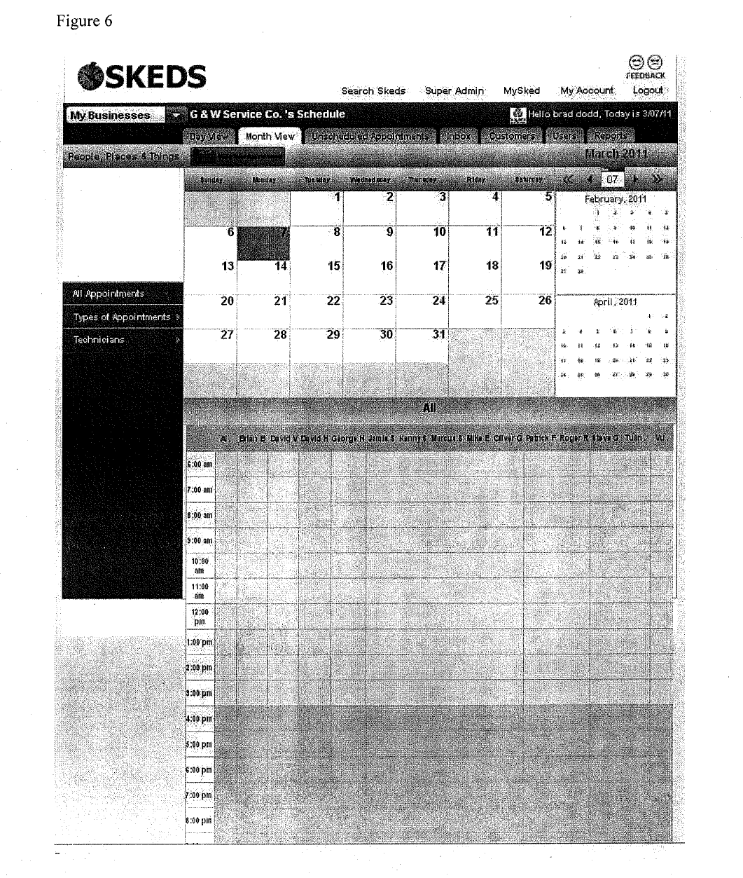

FIG. 6 illustrates the full view a particular month of the schedule administrator.

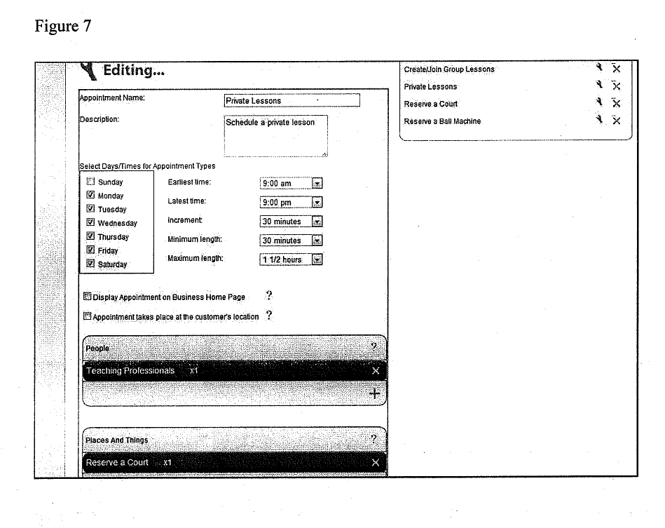

FIG. 7 provides an example of setting up a private lesson with a tennis pro. An Owner would create an appointment type and provide a name for the appointment, here its “Private Lessons.” The Owner would then need to select both “People” and “Places and Things” at the bottom of the page to ensure that the proper schedules are combined. “People” being the tennis professional and “Places and Things” being the court that is required to perform the lesson. The Owner sets the times available, the days available, the minimum and maximum length, and identifies all the required parties for the appointment to take place.

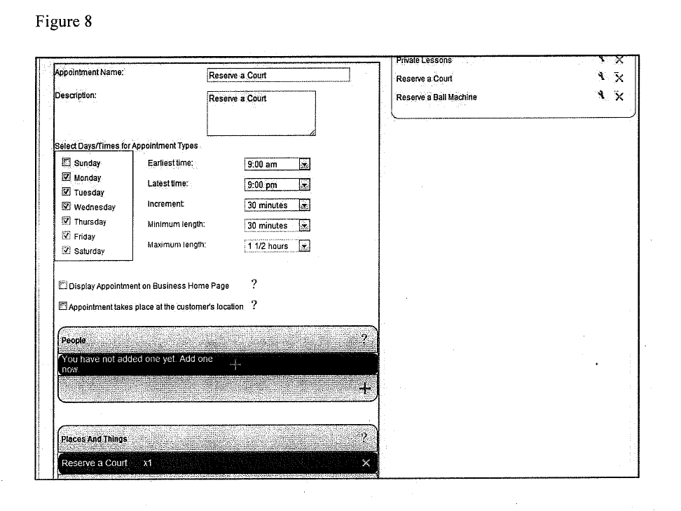

FIG. 8 shows a slightly different example from FIG. 7. This example is a customer simply wanting to reserve a court with no teaching professional. Thus, whereas a professional was required in FIG. 7, that person is not required here. However, the other features are still required. Thus, the customer would choose “Places and Things” and not “People,” because only the court is essential to setting the appointment. Where more than one person is involved, be the user customers to join.” This group appointment feature will enable customers to view open group appointments on a schedule and join them. If the appointment is for one customer only, other customers will see a “reserved” notation on the certain time slot in the schedule of employees.

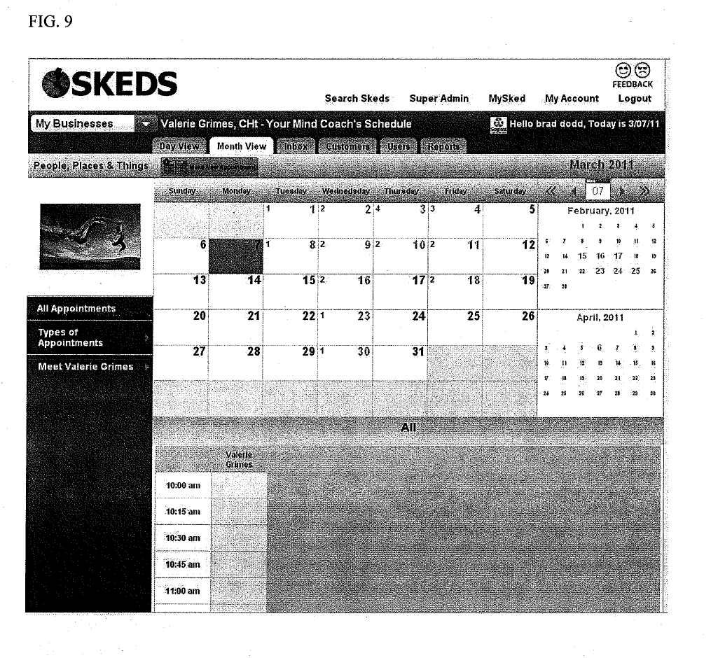

FIG. 9 illustrates a simple month view with only an owner.

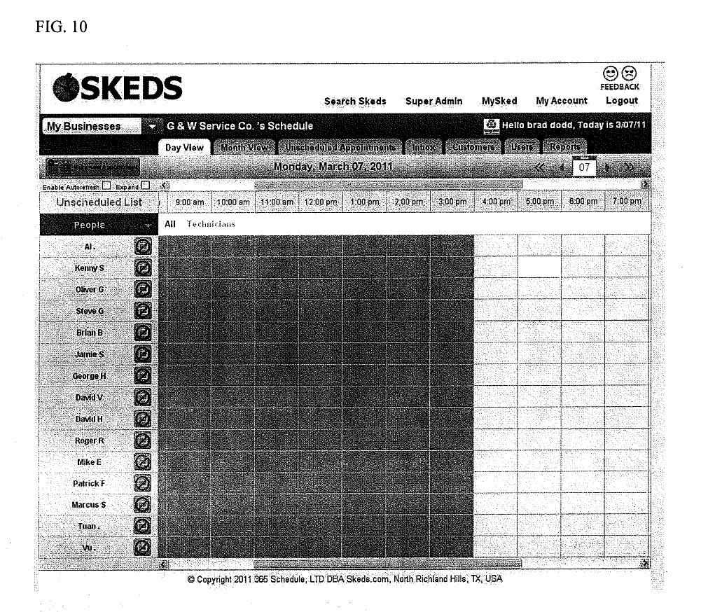

FIG. 10 illustrates the full view day view of the Schedule Administrator for a given schedule.

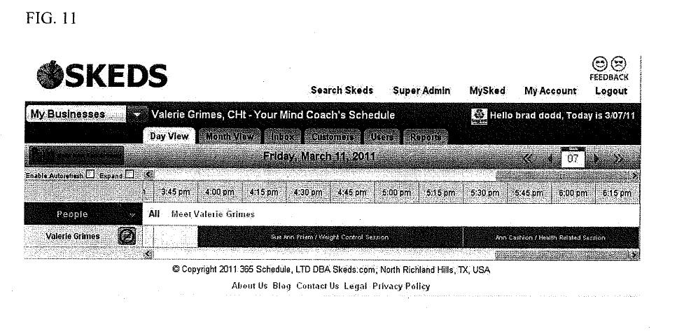

FIG. 11 illustrates simple view of the Day view of the schedule admin for a single user account.

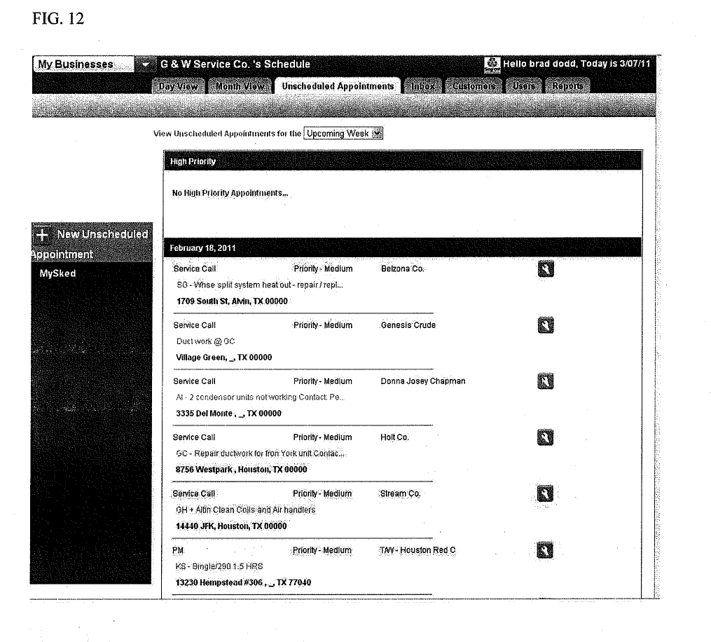

FIG. 12 illustrates that “unscheduled” appointments may exist on a user's profile, but that the appointments have not yet been placed on a definitive date. This provides the profile with an advanced “to do” list and allows the Owner of the profile to manipulate those free appointments where appropriate.

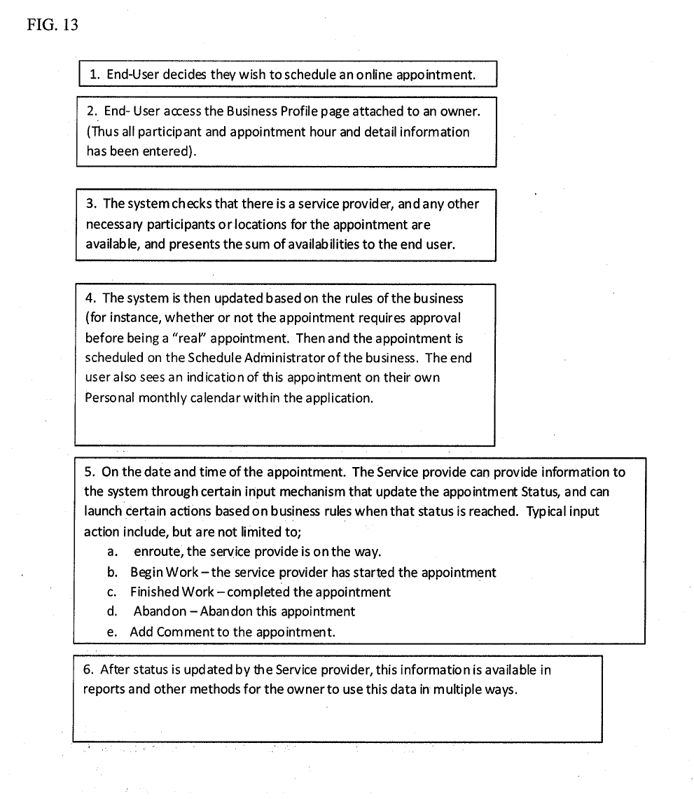

FIG. 13 shows a six step process to schedule an online appointment. First, the user determines to schedule an appointment, they access a schedule of a business which they are interested in scheduling an appointment. The system checks the necessary requirements for each and every required Person, Place, or Thing that may be required for the appointment and provides an output of the available times for the end user. The system then utilizes the criteria for the business and checks to make sure that the appointment can be set, or whether some additional action is needed by the business. Once set, the end user's schedule indicates this appointment on their own personal calendar. On the day of the appointment, the service can provide information through the system to provide updates as to the status of the appointment, and certain actions may be launched based on that status. For example, the status may be set that the service provider is en route, or that the work has begun or ended, or that the appointment was abandoned. Finally, one can add a comment to the appointment. After the completion of the appointment, the status is updated by the service provider and the information related to the appointment is available for the owner to mine the data for future use.

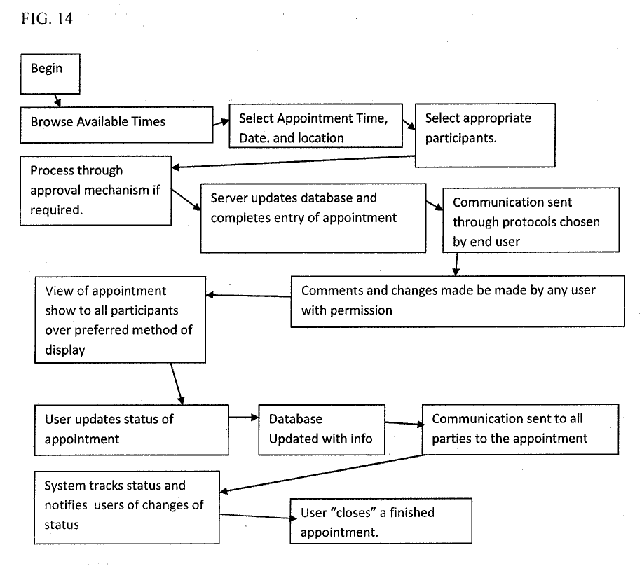

FIG. 14 identifies a 14 step process to create and manage a particular appointment. A user browses available times for an appointment, selects a time, date, and location, and selects the appropriate participants, if multiple persons are needed. The appointment is processed to approval, if such approval is needed to set the appointment. The server updates the database and completes the entry of the appointment, which can now be seen on the schedule. Communication is sent through protocols chosen by the end user, and comments and changes may be made, depending on the permissions set for the appointment. The appointment can be viewed by all participants. A user updates their status on an appointment, and the database updates the information. Communication is sent to all parties in the appointment. The system can then track the modifications of the appointment and the current status of the appointment and notify users of the changes in the status. An end user closes a finished appointment.

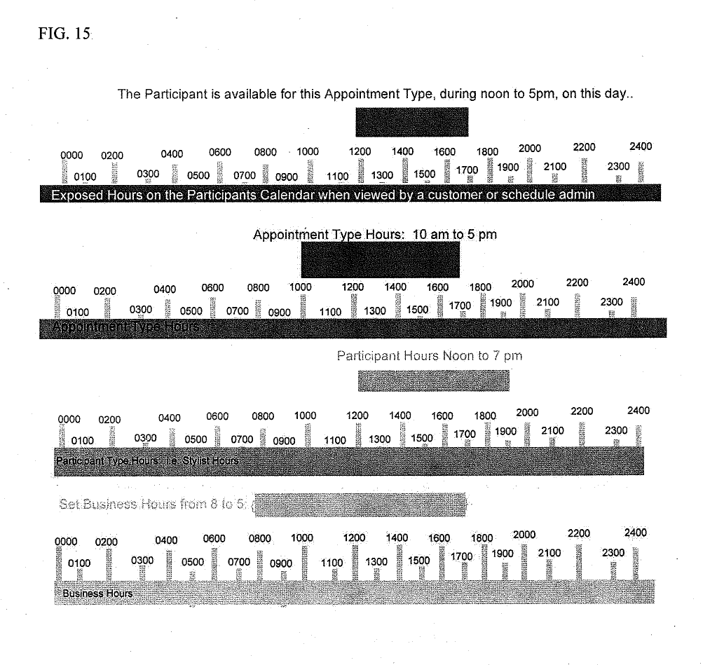

FIG. 15 identifies a comparison between four schedules, and illustrates the times when each of the schedules is available for the particular appointment, based on the criteria of the particular appointment. The combination of the four schedules then provides a user with the various times when the appointment, with each of the four entities, is available.

The invention now being fully described, it will be apparent to one of ordinary skill in the art that many changes and modifications can be made thereto without departing from the spirit or scope of the invention.

What is claimed is:

1. A method for creating a real time multi-person scheduling system accessible by multiple parties via a Data Transmission Protocols comprising:
creating records in a database, including one or more persons, places, or things, wherein the database entries of said persons, places, or things, are accessible to other users;
providing a first interface to enable one or more persons to access said database of information and receiving a set of criteria that defines the availability of a user;
providing a second interface which enables a second user seeking the availability of another person, place, or thing, access to the availability and criteria for said the other person, place, or thing, and creates a database entry for the mutually agreeable time for an appointment based on the criteria set by both entities.

2. The method of claim 1 further providing a third interface to set criteria regarding communicating information essential for the appointment, via text, electronic mail, or phone.

3. The method of claim 2, further providing that the text or electronic mail messages contain an encoded message which communicates information regarding the status of an appointment.

4. The method of claim 2 further comprising communicating the setting of a schedule via text.

5. The method of claim 2 further comprising communicating the setting of a schedule via email.

6. The method of claim 2 further comprising communicating the setting of a schedule via phone.

7. The method of claim 4 further comprising modifying said schedule via the text received.

8. The method of claim 5 further comprising modifying said schedule via the email received.

9. The method of claim 1, wherein the scheduled appointment is binding on both parties;
and providing a third interface for paying for said appointment.

10. The method of claim 1, wherein the scheduled appointment is pending approval of one or both parties.

11. A method for scheduling appointments and tracking the start and completion of an appointment comprising:
creating records in a database, including one or more persons, places, or things, wherein the database entries of said persons, places, or things, are accessible to other users;
providing a first interface to enable one or more persons to access said database of information and receiving a set of criteria that defines the availability of a user;
providing a second interface which enables a second user seeking the availability of another person, place, or thing, access to the availability and criteria for said the other person, place, or thing, and creates a database entry for the mutually agreeable time for an appointment based on the criteria set by both entities; and recording in a database the start time for an appointment and the stop time for an appointment.

12. The method of claim 10 where the total time a person is attending an appointment is utilized for determining the hours worked for paying an employee.

13. The method of claim 10 where the total time a person is attending an appointment is utilized for billing a client for services rendered.

14. A method for tracking the status of an appointment comprising:
creating records in a database, including one or more persons, places, or things, wherein the database entries of said persons, places, or things, are accessible to other users;
providing a first interface to enable one or more persons to access said database of information and receiving a set of criteria that defines the availability of a user;
providing a second interface which enables a second user seeking the availability of another person, place, or thing, access to the availability and criteria for said the other person, place, or thing, and creates a database entry for the mutually agreeable time for an appointment based on the criteria set by both entities; means for tracking the start and stop times of an appointment in a database; completing a first appointment; means for notifying a second appointment that the first appoint is complete; and providing an estimate time for the appointment.

15. A method of claim 13 further comprising tracking the schedule of an employee based on the database entries entered from appointments.

16. The method of claim 13 where the total time a person is attending an appointment is utilized for determining the hours worked for paying an employee.

17. The method of claim 13 where the total time a person is attending an appointment is utilized for billing a client for services rendered.

18. The method of claim 13 comprising means for notifying a third appointment that the first appointment is complete.

19. The method of claim 13 comprising means for notifying all appointments later that day that the status of the schedule has been updated.

20. A combination online calendar, social network, and advertising product created by a method comprising:
creating records in a database, including one or more persons, places, or things, wherein the database entries of said persons, places, or things, are accessible to other users;
providing a first interface to enable one or more persons to access said database of information and receiving a set of criteria that defines the availability of a user;
providing a second interface which enables a second user seeking the availability of another person, place, or thing, access to the availability and criteria for said the other person, place, or thing, and creates a database entry for the mutually agreeable time for an appointment based on the criteria set by both entities; receiving personal information from a customer and storing such information in a database; creating a coupon to target similar customers based on the profile of the customer who made an appointment; and publishing an appointment on a social network.

21. An automated scheduling system that facilitates real time scheduling via an accessible website, comprising:
A. a database system accessible via a website; said database comprising multiple entries of individually customizable data; a job position is added, for each job position added the personal information for each individual is added; and for each position and personal information added, adding a schedule to create a personalized database for that profile;
B. a section in the website template that allows a user to add a category for places or things, including appointments, which are viewable by other users;
C. for each category containing as many types of appointments as are necessary for the user's business; said user may set times where individuals and appointments are available to customers; said user may set the duration for each individual appointment and sets a minimum and maximum duration.

22. The system of claim 20 further comprising means for make changes to appointments via a Database Transmission Protocol, where each appointment has a unique code and each appointment may be updated via communications over any one Database Transmission Protocol.

23. The system of claim 20 further comprising means for tracking appointment by communicating the end of an appointment, and a template for an employer to review employee's appointments and hours worked based on timestamps on communications, which are held in database.

24. The system of claim 20 further comprising a notification system for notifying the next customer that prior appointment just ended and that employee will be arriving.

25. A scheduling system comprising:
A computer server comprising a processor and a database of calendar schedules of a plurality of persons and a plurality of things; the system configured to receive a request for an appointment on a selected person's schedule wherein the appointment on the selected person's schedule also requires an appointment on a schedule of a thing; the system returning at least one time which is available on both the selected person's schedule and the selected thing's schedule.

26. The system of claim 24 wherein the thing is selected from the group consisting of a room, a vehicle, an object, a piece of equipment, and a physical location.

27. A scheduling system comprising:
A computer server comprising a processor and a database of calendar schedules of a plurality of persons and a plurality of things; the system configured to receive a request for an appointment on a selected person's schedule wherein the appointment on the selected person's schedule also requires an appointment on a schedule of a second person, and a schedule of a thing; the system returning at least one time which is available on the selected person's schedule, the second person's schedule, and the selected thing's schedule.

28. The system of claim 26 wherein the second person is in a service industry.

29. The system of claim 27 wherein the second person in a service industry is selected from the group consisting of food and beverage, exercise and fitness, hair nail, and salon services, a tennis professional, golf professional, plumber, professional corporations, real estate, gardening and yard maintenance, medical and dental, repair and maintenance, cable or internet installation, and third party delivery services.

30. A scheduling system comprising:
A computer server comprising a processor and a database of calendar schedules of a plurality of persons and a plurality of things; the system configured to receive a request for an appointment on a selected person's schedule wherein the appointment on the selected person's schedule also requires an appointment on a schedule of a second person, a schedule of a thing, and a schedule of a physical location; the system returning at least one time which is available on the selected person's schedule, the second person's schedule, the things schedule, and the schedule of the physical location.

31. The system of claim 29 wherein the second person is in a service industry.

32. The system of claim 30 wherein the second person in a service industry is selected from the group consisting of food and beverage, exercise and fitness, hair nail, and salon services, a tennis professional, golf professional, plumber, professional corporations, real estate, gardening and yard maintenance, medical and dental, repair and maintenance, cable or internet installation, and third party delivery services.
